(19) United States
(12) Patent Application Publication
(10) Pub. No.: US 2009/0113002 A1
(43) Pub. Date: Apr. 30, 2009

(54) Electronic Message Attachment Options

(75) Inventors: Samuel N. Zellner, Dunwoody, GA (US); Jerry Chieh Liu, Atlanta, GA (US)

Correspondence Address: AT&T Legal Department - TKHR;Attn: Patent Docketing, One AT&T Way, Room 2A-207, Bedminster, NJ, 07921, US

(73) Assignee: AT&T BLS INTELLECTUAL PROPERTY, INC., Wilmington, DE (US)

(21) Appl. No.: 11/928,824

(22) Filed: Oct. 30, 2007

(51) Int. Cl. G06F 15/16

(52) U.S. Cl. 709/206

(57) ABSTRACT

Included are embodiments for providing an attachment for a message. At least one embodiment of a method includes receiving a message from a sender, the message configured to be sent to at least one recipient, the message including an attachment and determining whether the at least one recipient is designated to receive the attachment. Some embodiments include determining a desired attachment representation for the attachment and in response to determining a desired attachment representation for the attachment, sending the message for delivery to the at least one recipient.

### TECHNICAL FIELD

This application relates to messaging. More specifically this application relates to attachments in electronic messages.

### BACKGROUND

As messaging has evolved, users have desired to send messages with attached files, such as documents, images, videos, etc. While attachments to messages have provided the ability to include additional information than what has been disclosed in the body of the message, oftentimes, attachments can consume an inordinate amount of bandwidth and/or storage space. Additionally, as some message providers and message clients have limits on storage space, the inclusion of large attachments may become a problem.

### SUMMARY

Included are embodiments for providing an attachment for a message. At least one embodiment of a method includes receiving a message from a sender, the message configured to be sent to at least one recipient, the message including an attachment and determining whether the at least one recipient is designated to receive the attachment. Some embodiments include determining a desired attachment representation for the attachment and in response to determining a desired attachment representation for the attachment, sending the message for delivery to the at least one recipient.

Also included are embodiments of a system. At least one embodiment of a system includes a receiving component configured to receive a message from a sender, where the message designates at least one user and the message includes an attachment; and a first determining component configured to determine whether the recipient desires to receive the attachment. Some embodiments include a second determining component configured to determine whether the recipient desires to receive a link of the attachment and a providing component configured to provide the received message to the recipient.

Also included are embodiments of a computer readable storage medium. At least one embodiment of a computer readable storage medium includes first receiving logic configured to receive a message that includes an attachment, where the message is sent from a sender and the message is configured for delivery to at least one recipient; and first determining logic configured to determine whether the received message includes an indication to store the attachment at a remote location. Some embodiments include storing logic configured to, in response to determining that the message includes an indication to store the attachment at a remote location, store the attachment at the remote location.

Other systems, methods, features, and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

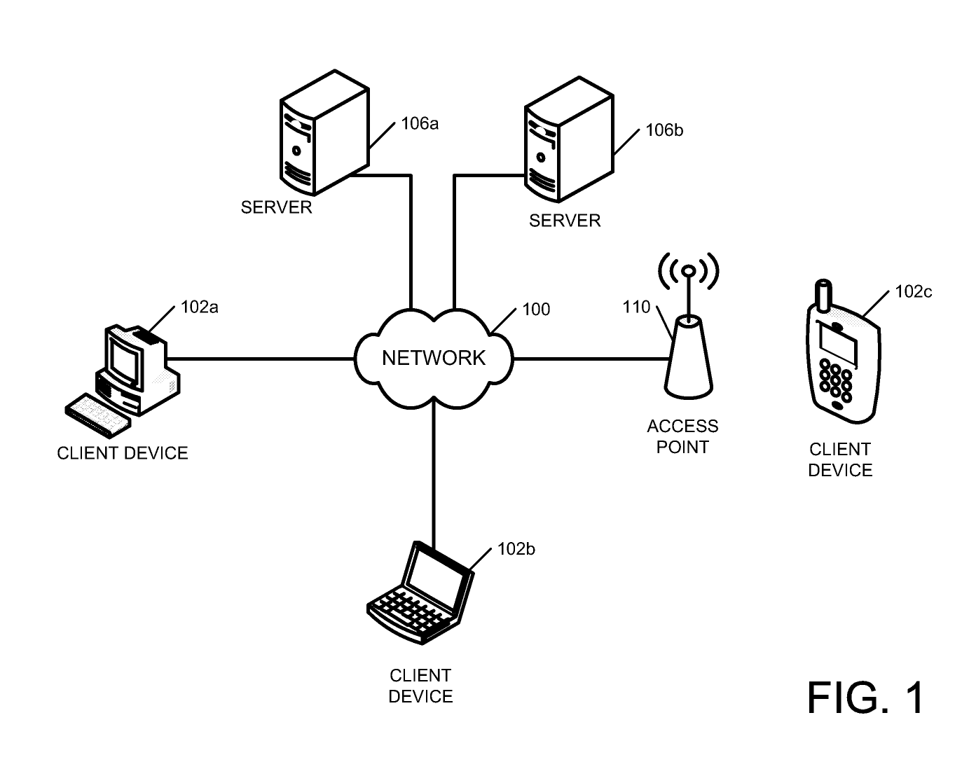

FIG. 1 illustrates an exemplary embodiment of a communications network, which may be configured to facilitate communication of data.

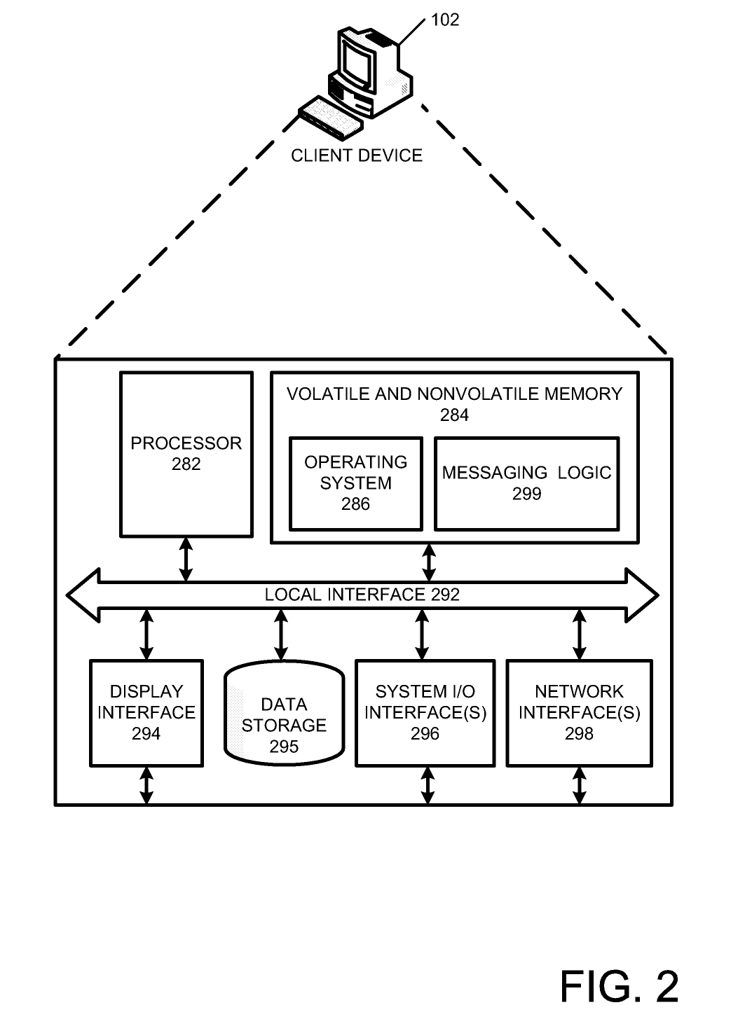

FIG. 2 illustrates an exemplary embodiment of a client device, which may be configured to provide options for uploading and/or downloading content, such as in the network from FIG. 1.

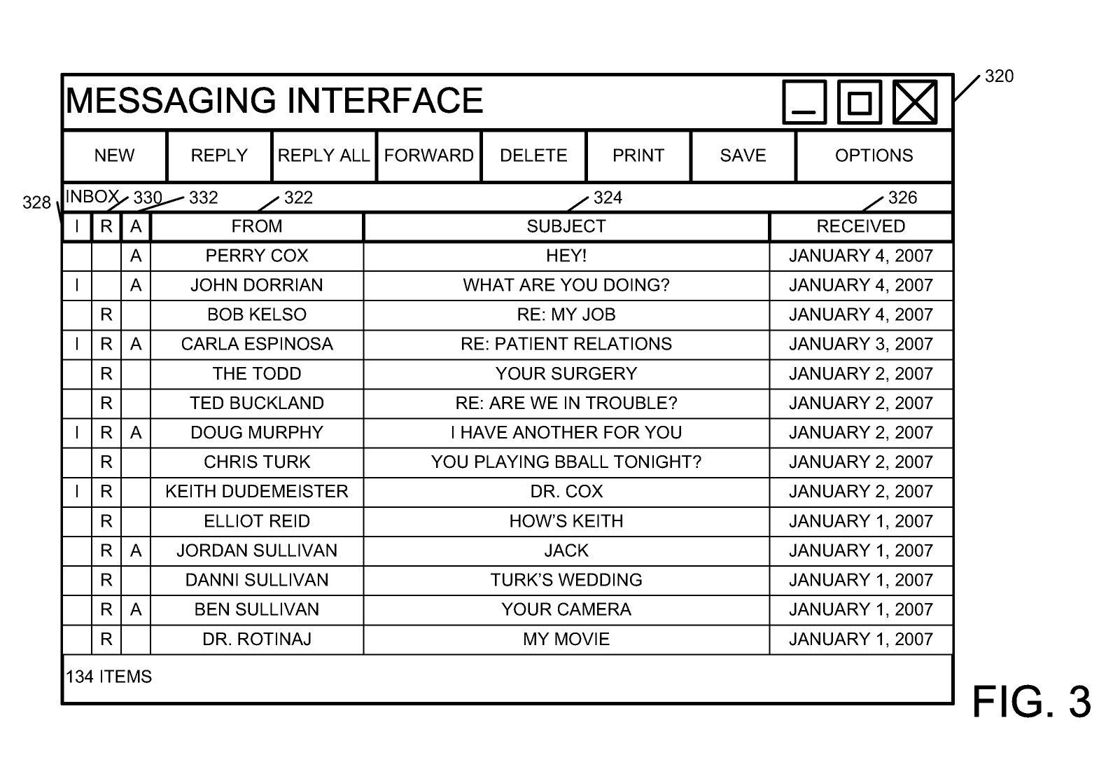

FIG. 3 illustrates an exemplary embodiment of a messaging interface, as may be provided by the client device from FIG. 2.

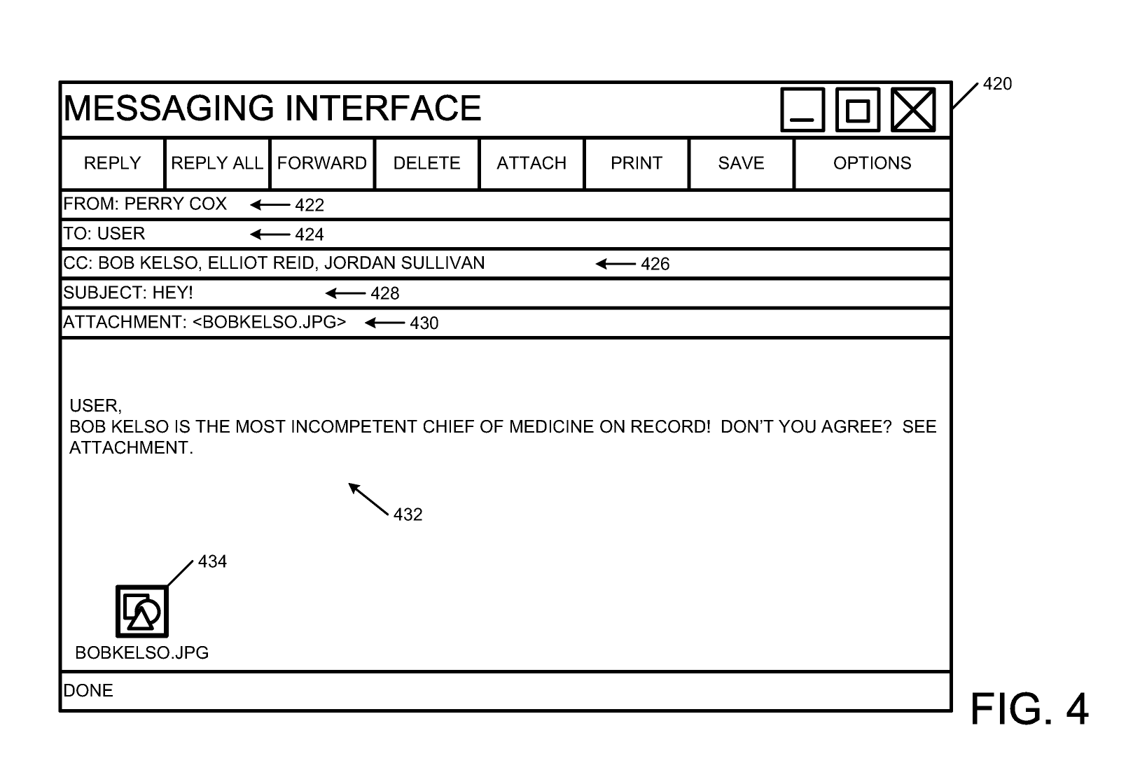

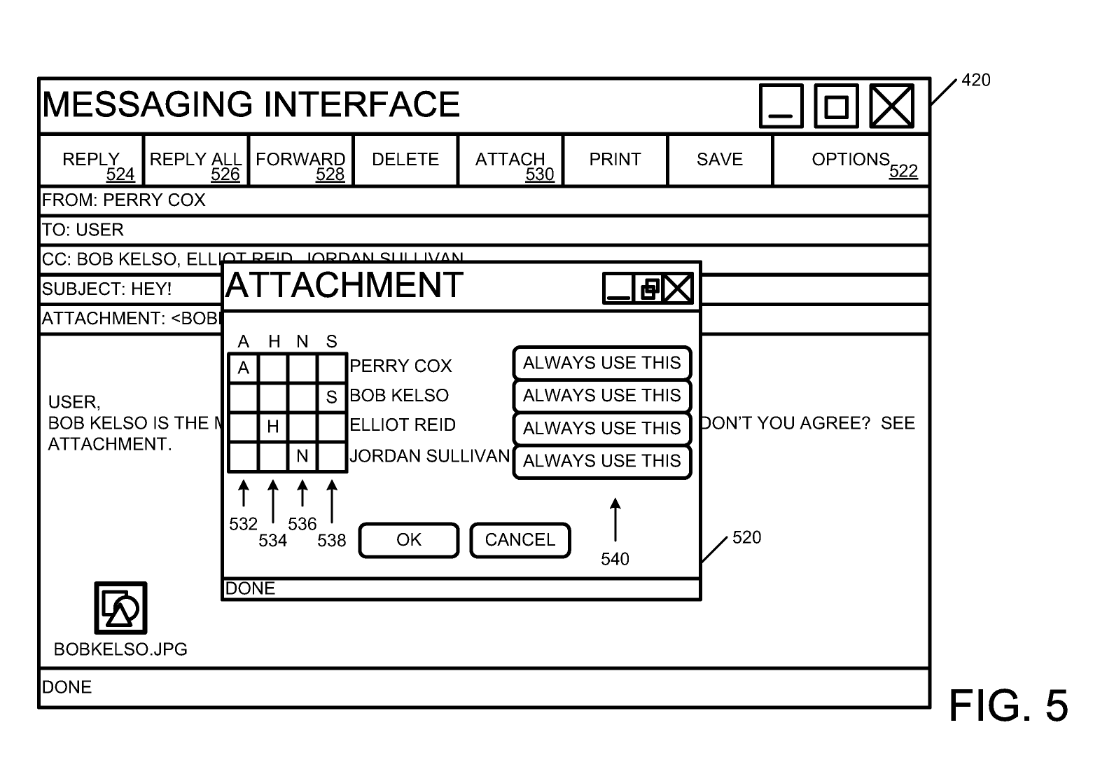

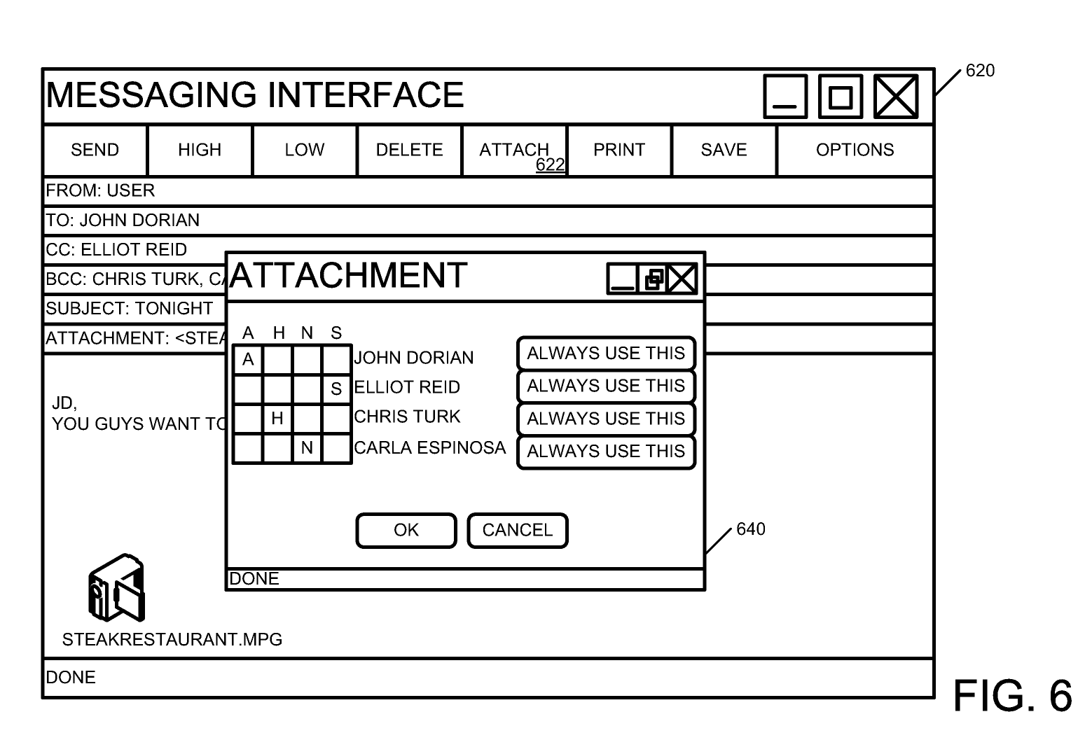

FIG. 4 illustrates an exemplary embodiment of a messaging interface configured to provide a received message, similar to the interface from FIG. 3.

FIG. 5 illustrates an exemplary embodiment of an attachment window for determining attachment options for an outgoing reply message, similar to the interface from FIG. 4.

FIG. 6 illustrates an exemplary embodiment of an attachment window for providing attachment options for an initiated outgoing message, similar to the attachment window from FIG. 5.

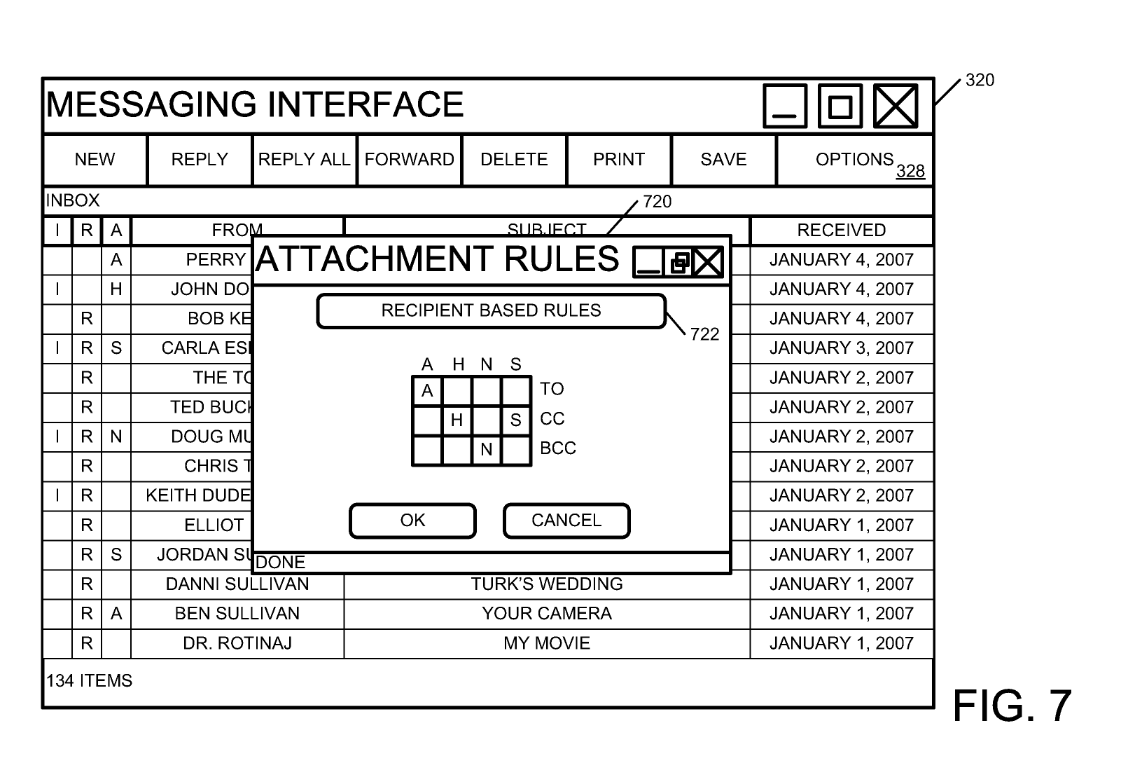

FIG. 7 illustrates an exemplary embodiment of an attachment rules window for attaching files to outgoing messages, similar to the attachment window from FIG. 6.

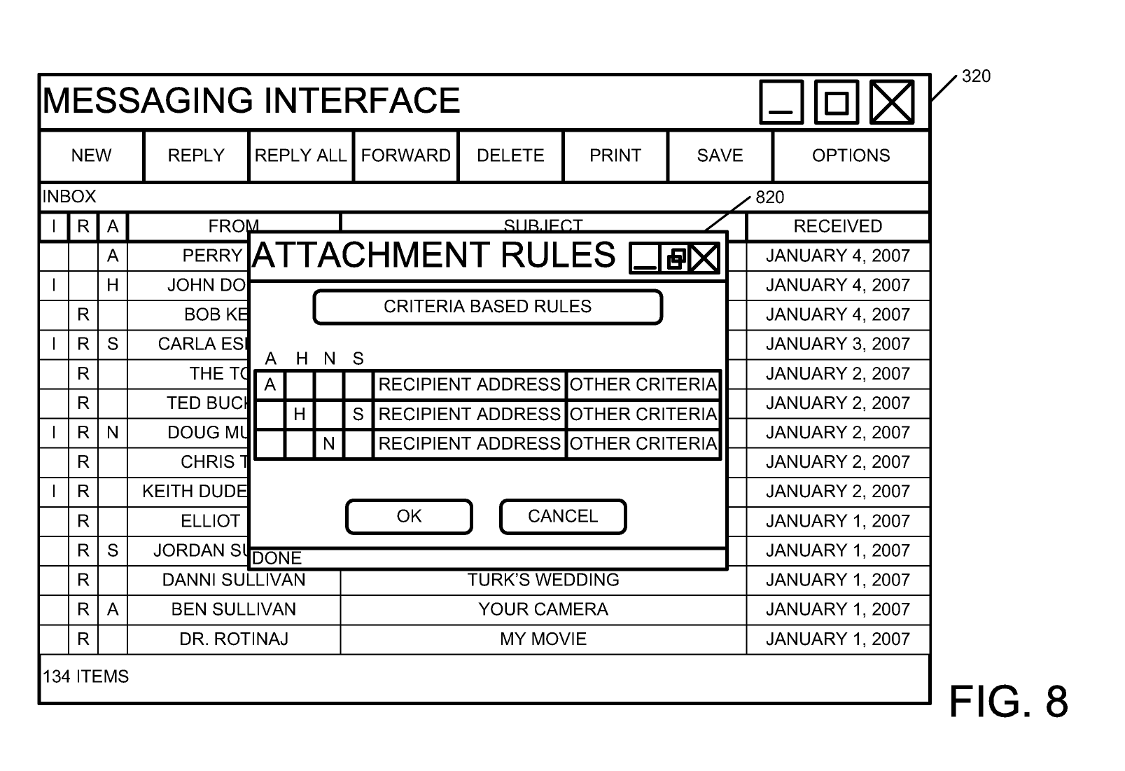

FIG. 8 illustrates an attachment rules window for determining rules based on a desired recipient, similar to the attachment rules window from FIG. 7.

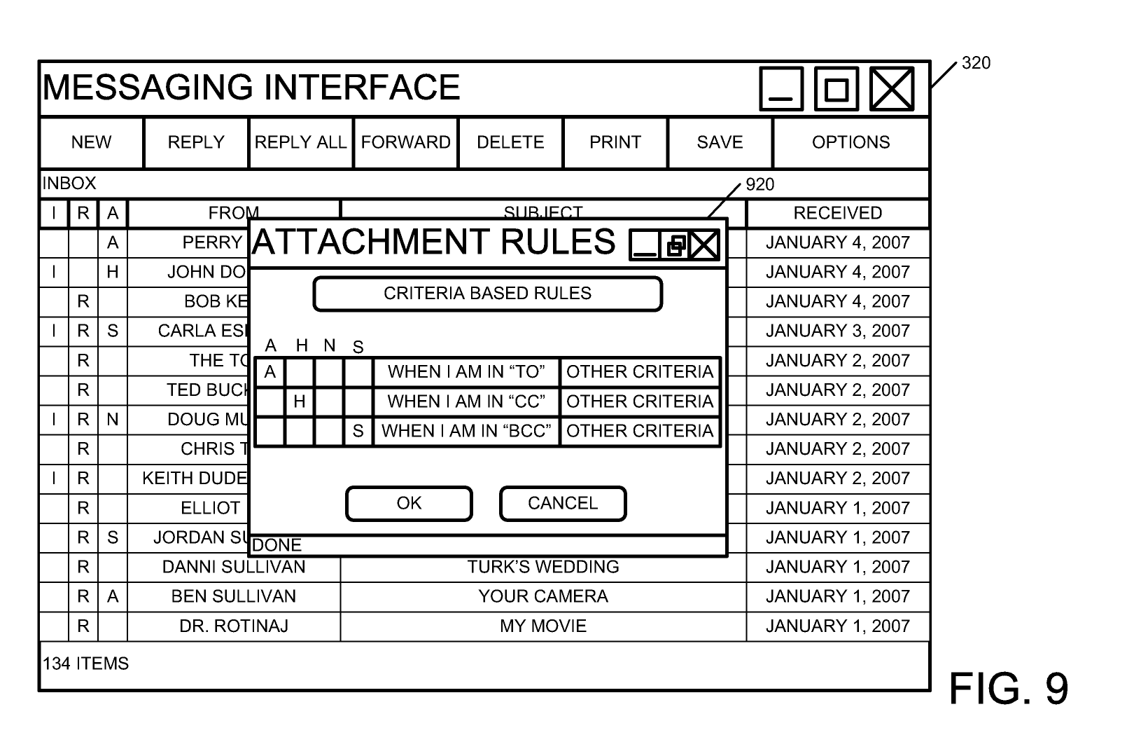

FIG. 9 illustrates an exemplary embodiment of an attachment rules window for determining attachment rules for received messages, similar to the attachment rules window from FIG. 8.

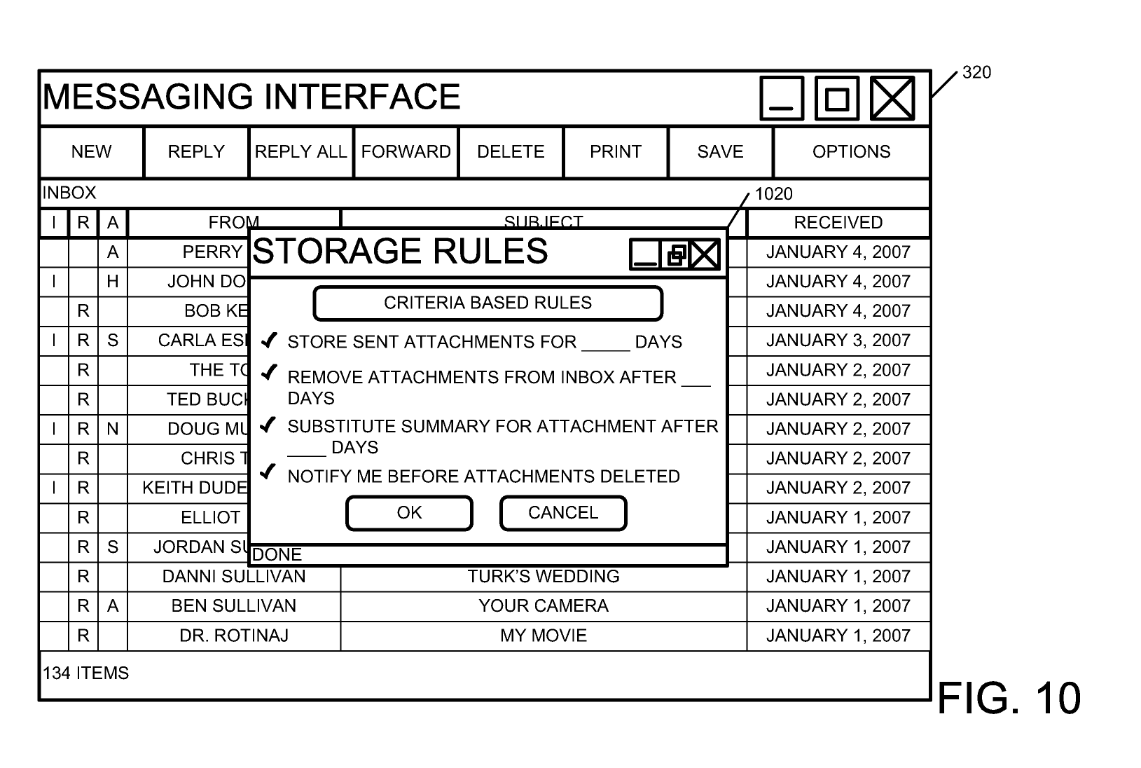

FIG. 10 illustrates an exemplary embodiment of a storage rules window, similar to the attachment rules window from FIG. 9.

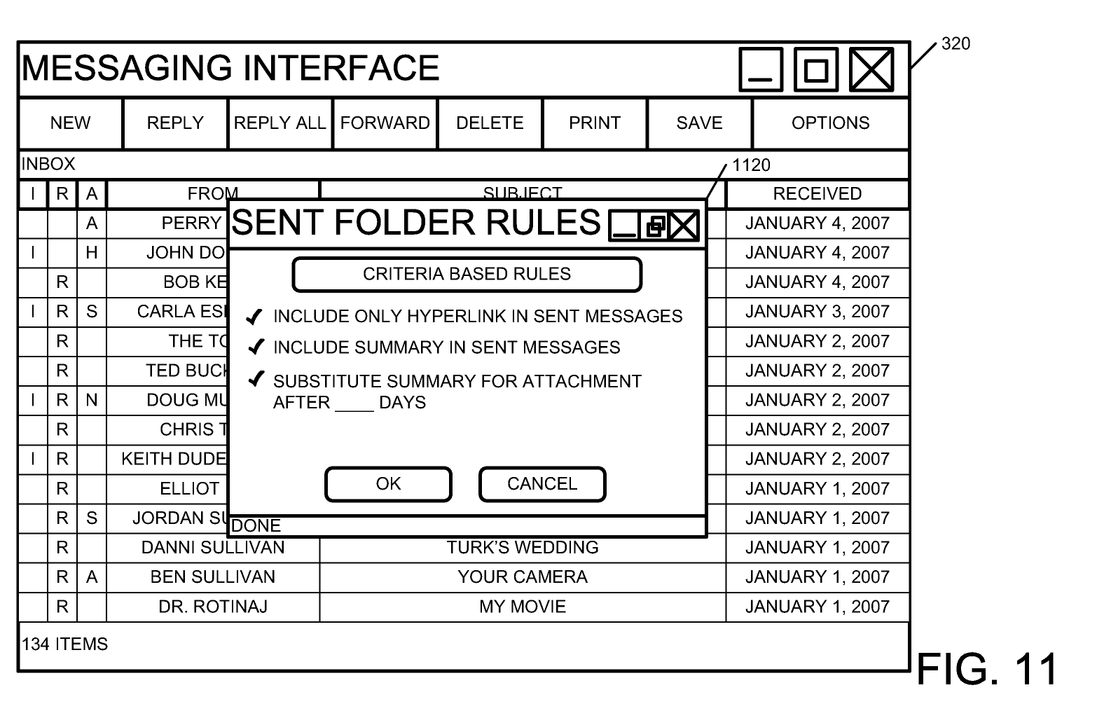

FIG. 11 illustrates an exemplary embodiment of a sent folder rules window, similar to the attachment rules window from FIG. 10.

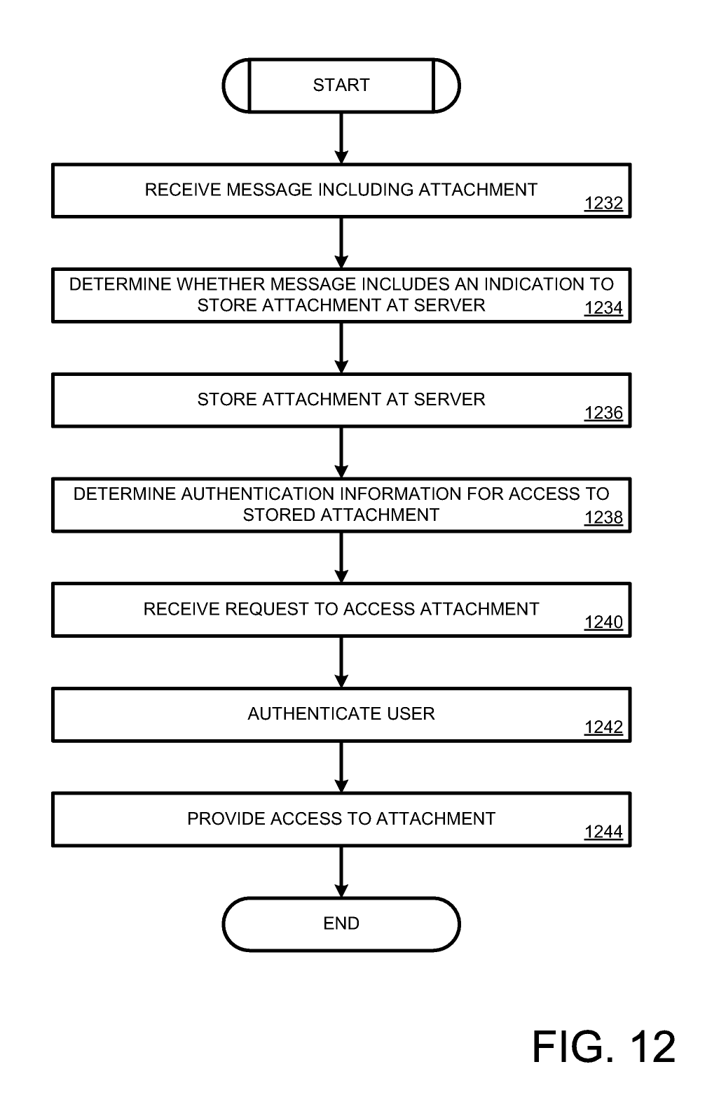

FIG. 12 depicts a flowchart illustrating an exemplary process for providing access to an attachment, such as may be provided in the network from FIG. 1.

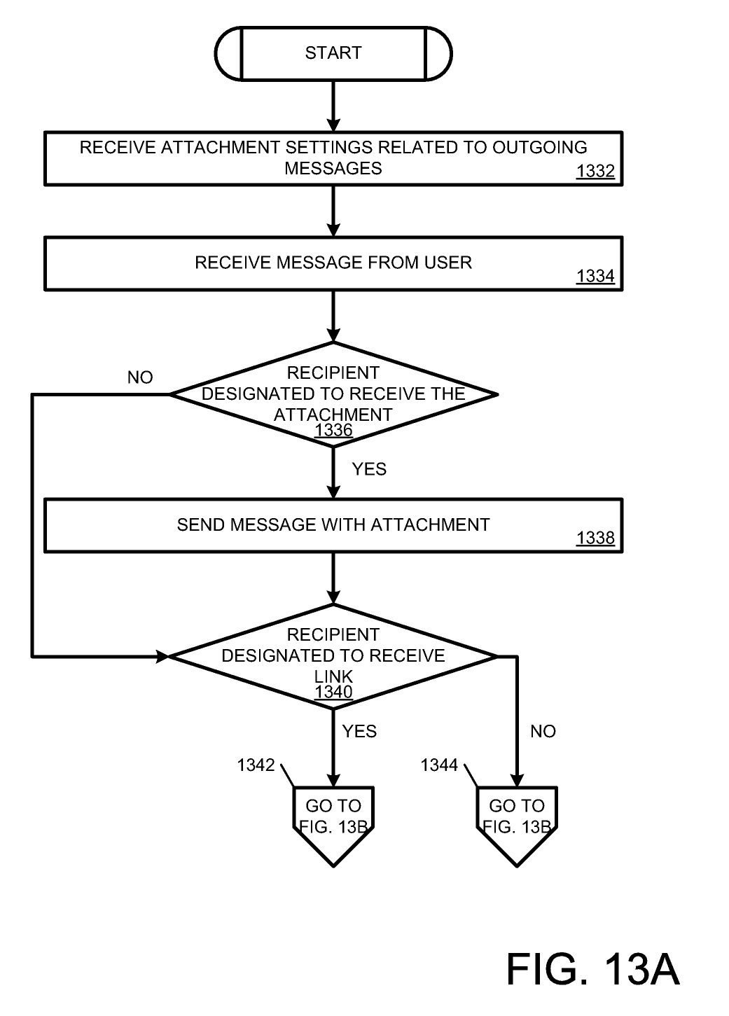

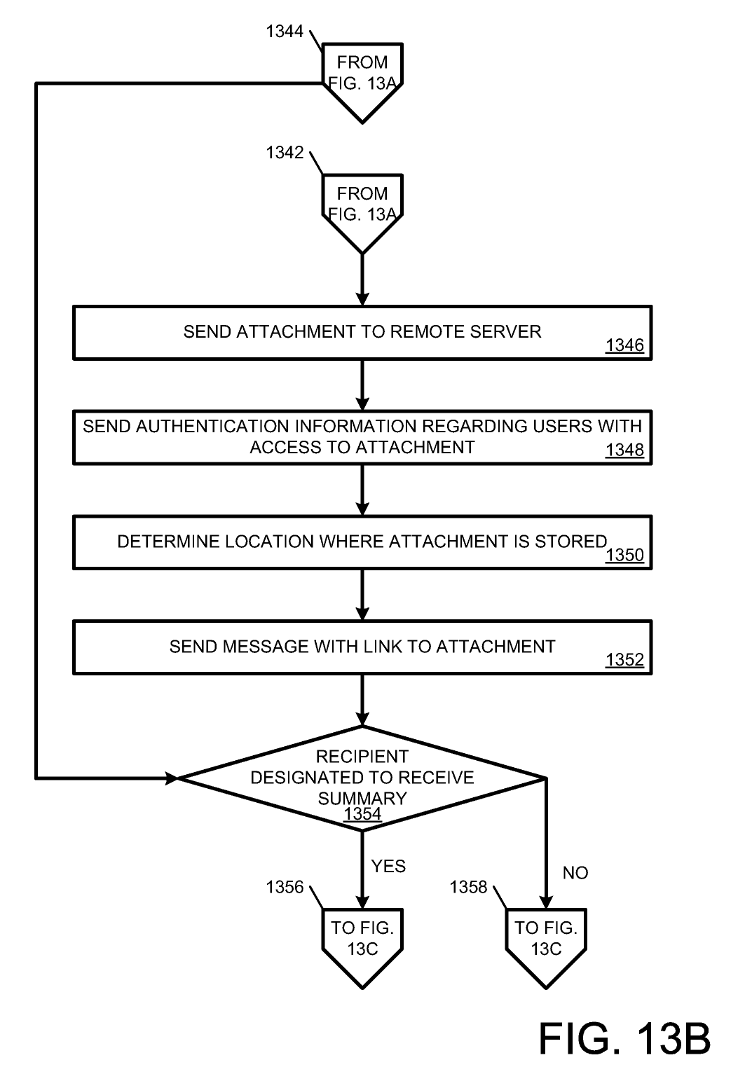

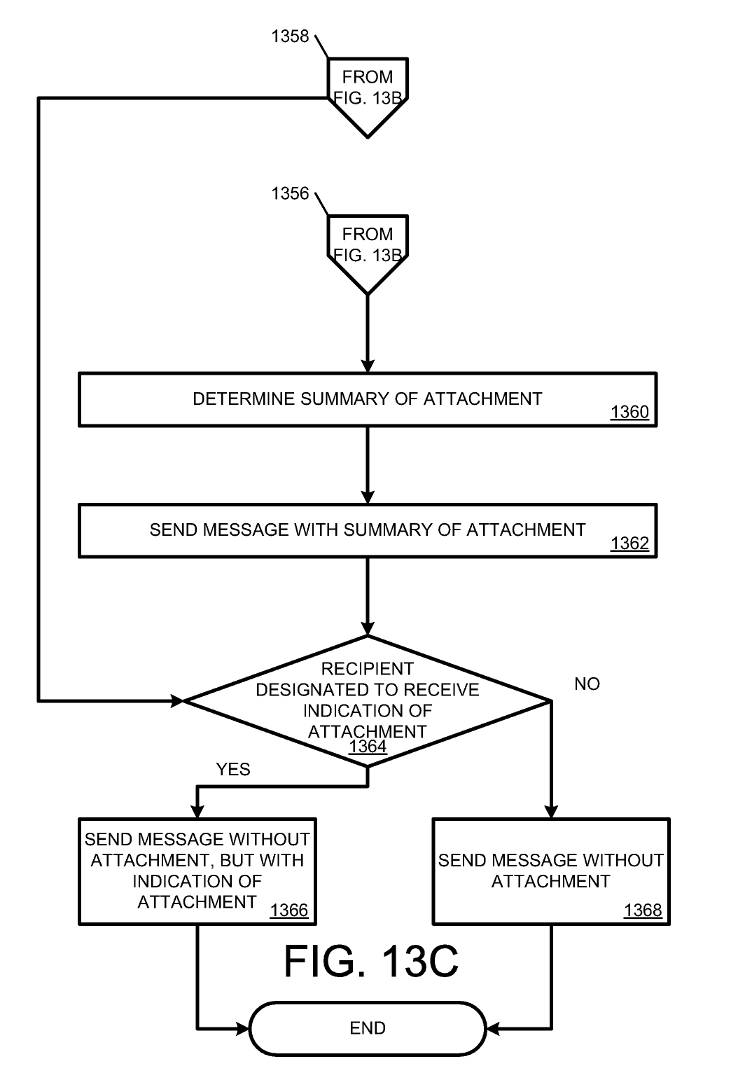

FIGS. 13A-13C depict a flowchart illustrating an exemplary process for sending a message, similar to the flowchart from FIG. 12.

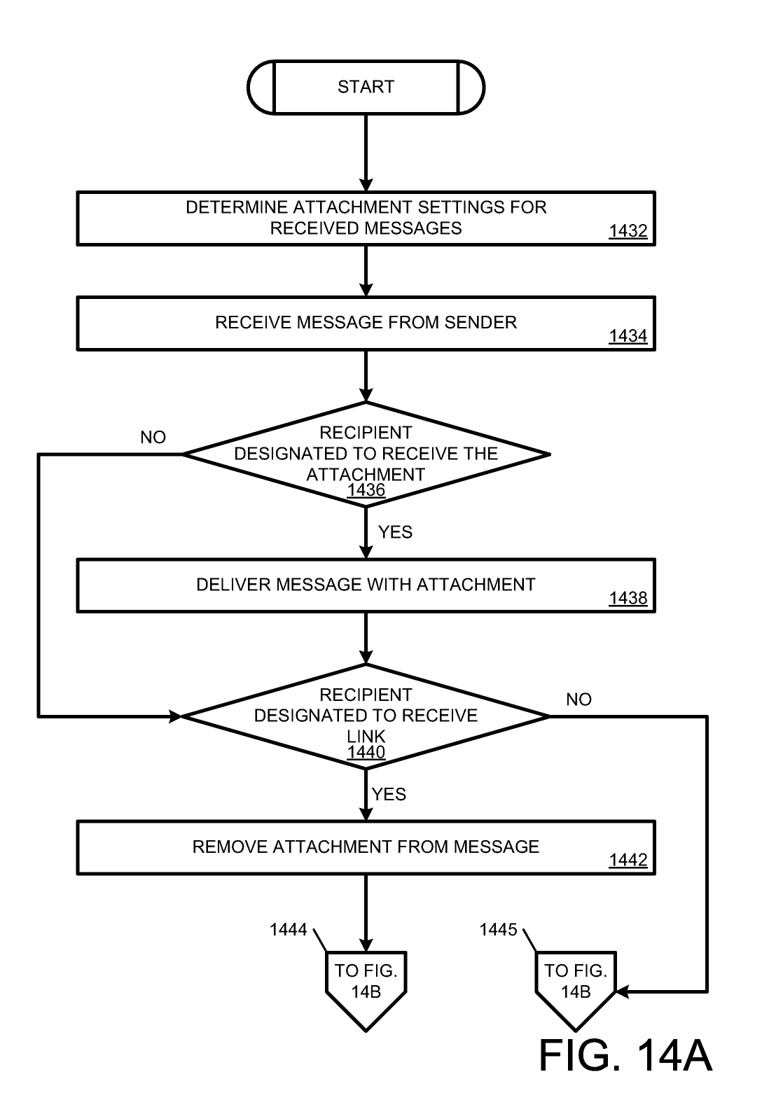

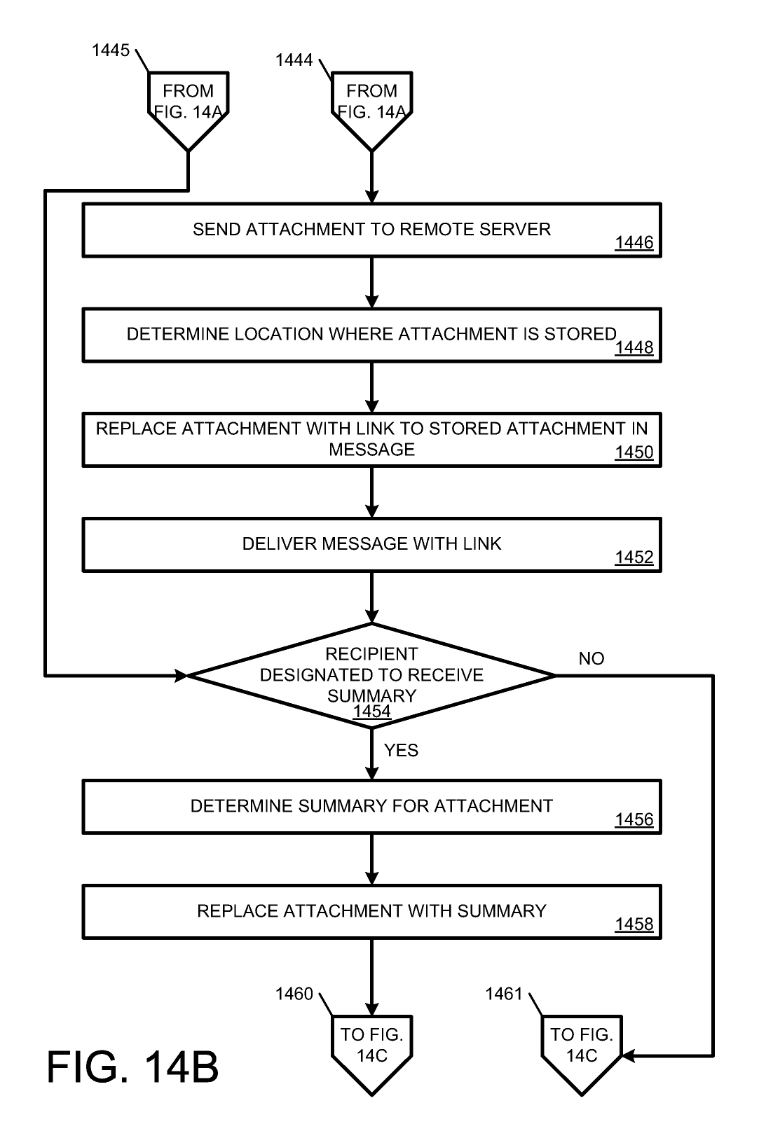

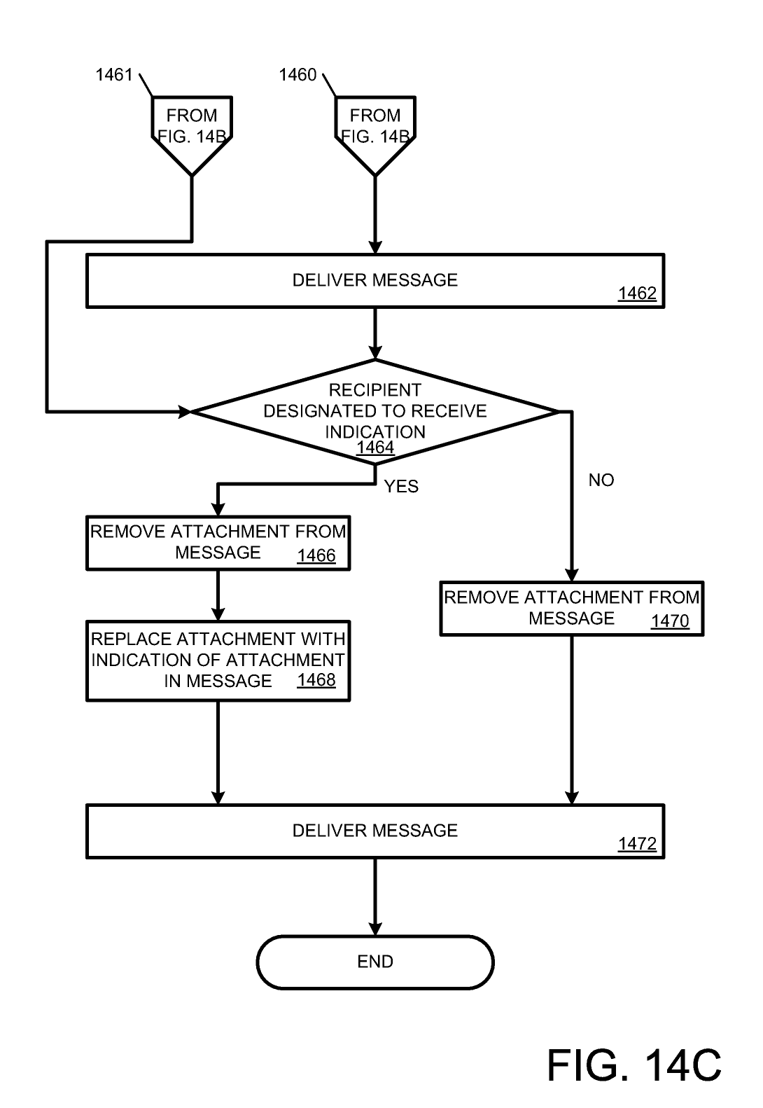

FIGS. 14A-14C depict a flowchart illustrating an exemplary process for delivering a message with attachment options, similar to the flowchart from FIGS. 13A-13C.

### DETAILED DESCRIPTION

Referring to the drawings, FIG. 1 illustrates an exemplary embodiment of a communications network, which may be configured to facilitate communication of data. More specifically, as illustrated in the nonlimiting example of FIG. 1, a network 100 may be utilized and include a Wide Area Network (WAN), such as the Internet, a Public Switched Telephone Network (PSTN), Mobile Communications Network (MCN) and/or other network. Similarly, the network 100 may include a wireline and/or a wireless Local Area Network (LAN). Regardless of the communications medium and protocol, the network 100 may be coupled to one or more client devices 102a, 102b, 102c. The client devices 102a, 102b, 102c (collectively referred to as client device 102) may include a personal computer, laptop, or other device that is configured for communicating with the network 100. While the client devices 102a, 102b may be wireline devices, the client device 102c may be configured for wireless communications and be configured to communicate with the network 100 via an access point 110 or other wireless communications device.

Additionally included in the nonlimiting example of FIG. 1, is the access point 110. The access point may be configured as a wireless cellular tower, a Wireless Fidelity (Wi-Fi) hotspot, a Worldwide Interoperability for Microwave Access (WIMAX) tower, and/or other wireless node.

Also included in the nonlimiting example of FIG. 1 are servers 106a and 106b. The servers 106a and 106b may be configured to facilitate the communication of electronic messages, which may include email, instant messages, Short Message Service (SMS) messages audio messages, video messages, and/or other electronic messages. In some embodiments, the server 106a may be configured to provide messaging services to an account associated with the client device 102a. Similarly, in some embodiments, the server 106b may be configured to provide messaging services to one or more accounts associated with client devices 102b and 102c.

As a nonlimiting example, if a user of the client device 102a desires to send a message to a user of the client device 102b, the user may send the message to the server 106a. The server 106a can determine the desired recipient of the message and send the message to the server associated with that recipient (in this example server 106b). The server 106b can receive the message and inform the recipient that a message is being stored at the server 106b (or an associated data storage component). If, however, the message sender (e.g., client device 102a) and message recipient (e.g., client device 102b) are associated with the same server (e.g., server 106b), that server 106b can handle receipt and delivery of the message.

One should note that, while the diagram of FIG. 1 illustrates the servers 106a, 106b as single components, this is a nonlimiting example. More specifically, depending on the particular configuration, the servers 106a, 106b may include a plurality of servers, data storage components, and/or other components. Additionally, while the discussion with regard to FIG. 1 describes embodiments where messages are sent via the servers 106a, 106b, this is also a nonlimiting example, as in some embodiments, the servers may facilitate a communication pathway between the message sender and message recipient, but may be configured to receive only a copy of the messages sent.

FIG. 2 illustrates an exemplary embodiment of a client device 102, which may be configured to provide options for uploading and/or downloading content, such as in the network from FIG. 1. Although a wire-line device (e.g., the client device 102a) is illustrated, this discussion can be applied to wireless devices, as well. According to exemplary embodiments, in terms of hardware architecture, the client device 102 includes a processor 282, a memory component 284, a display interface 294, data storage 295, one or more input and/or output (I/O) device interface(s) 296, and/or one or more network interfaces 298 that are communicatively coupled via a local interface 292. The local interface 292 can include, for example but not limited to, one or more buses and/or other wired or wireless connections. The local interface 292 may have additional elements, which are omitted for simplicity, such as controllers, buffers (caches), drivers, repeaters, and receivers to enable communications. Further, the local interface 292 may include address, control, and/or data connections to enable appropriate communications among the aforementioned components. The processor 282 may be a device for executing software, particularly software stored in the memory component 284. The processor 282 can include any custom made or commercially available processor, a central processing unit (CPU), an auxiliary processor among several processors associated with the client device 102, a semiconductor based microprocessor (in the form of a microchip or chip set), a macroprocessor, and/or generally any device for executing software instructions.

The memory component 284 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 284 may incorporate electronic, magnetic, optical, and/or other types of storage media. One should note that the memory 284 can have a distributed architecture (where various components are situated remote from one another), but can be accessed by the processor 282.

The software in the memory 284 may include one or more separate programs, which may include an ordered listing of executable instructions for implementing logical functions. In the example of FIG. 2, the software in the memory component 284 may include the messaging logic 299, as well as an operating system 286. The operating system 286 may be configured to control the execution of other computer programs and provides scheduling, input-output control, file and data management, memory management, and communication control and related services. The messaging logic 299 may be configured to facilitate communication of one or more messages (emails, instant messages, SMS messages, faxes, and/or other messages). Additionally, the messaging logic 299 may be configured to provide attachment options, as discussed in more detail below.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 284, so as to operate properly in connection with the operating system 286.

The Input/Output devices that may be coupled to the system I/O Interface(s) 296 may include input devices, for example but not limited to, a keyboard, mouse, scanner, touch screen, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more of the network interfaces 298 for facilitating communication with one or more other devices. More specifically, network interface 298 may include any component configured to facilitate a connection with another device. While in some embodiments, among others, the client device 102 can include the network interface 298 that includes a Personal Computer Memory Card International Association (PCMCIA) card (also abbreviated as “PC card”) for receiving a wireless network card, this is a nonlimiting example. Other configurations can include the communications hardware within the client device 102, such that a wireless network card is unnecessary for communicating wirelessly. Similarly, other embodiments include the network interfaces 298 for communicating via a wired connection. Such interfaces may be configured with Universal Serial Bus (USB) interfaces, serial ports, and/or other interfaces.

If the client device 102 includes a personal computer, workstation, or the like, the software in the memory 284 may further include a basic input output system (BIOS) (omitted for simplicity). The BIOS is a set of software routines that initialize and test hardware at startup, start the operating system 286, and support the transfer of data among the hardware devices. The BIOS is stored in ROM so that the BIOS can be executed when the client device 102 is activated.

When the client device 102 is in operation, the processor 282 may be configured to execute software stored within the memory component 284, to communicate data to and from the memory component 284, and to generally control operations of the client device 102 pursuant to the software. Software in the memory component 284, in whole or in part, may be read by the processor 282, perhaps buffered within the processor 282, and then executed.

One should note that while the description with respect to FIG. 2 includes the client device 102 as a single component, this is a nonlimiting example. More specifically, in at least one embodiment, the client device 102 can include a plurality of servers, personal computers, telephones, and/or other devices. Similarly, while the description of FIG. 2 describes the client device 102 as a personal computer, this is also a nonlimiting example. More specifically, depending on the particular exemplary embodiment, other components, such as the servers 106 and/or the access point 110 may include similar elements and/or logic.

Additionally, while the messaging logic 299 is illustrated in FIG. 2 as including a single software component, this is also a nonlimiting example. In at least one embodiment, the messaging logic 299 may include one or more components, embodied in software, hardware, and/or firmware. Additionally, while the messaging logic 299 is depicted as residing on a single device, such as client device 102, the messaging logic 299 may include one or more components residing on one or more different devices.

FIG. 3 illustrates an exemplary embodiment of a messaging interface 320, as may be provided by the client device 102 from FIG. 2. As illustrated, the email interface 320 may be configured as a messaging inbox. More specifically, the messaging interface 320 is configured with a from field 322, a subject field 324, and a received field 326. The from field 322 may be configured to provide an indication of the sender of a received message. The subject field 324 may be configured to provide a subject of the message, as designated by the sender. The received field 326 may be configured to indicate a date (and/or a time) the message was received.

Also included in the interface 320 are an importance field 328, an action field 330, and an attachment field 332. More specifically, the importance field may be configured to indicate whether the sender designated the received message as being of normal importance, of high importance, and/or of low importance. Other importance options may also be provided in the importance field 328. Similarly, the action field 330 may be configured to provide the user with an indication of whether the user (recipient of the message) has taken an action on the received message. More specifically, the action indicator 330 may be configured to indicate whether the user has opened the received message, replied to the received message, forwarded the received message, and/or taken other action with regard to the received message. Similarly, the attachment field may be configured to indicate whether an attachment is included in the received message.

FIG. 4 illustrates an exemplary embodiment of a messaging interface 420 configured to provide a received message, similar to the interface 320 from FIG. 3. As illustrated, the message interface 420 may be configured for display, in response to selection of a message from the interface 320, from FIG. 3. The message interface 420 may be configured to provide a from field 422, indicating the sender of the message. A to field 424 may be configured to indicate the recipient(s) of the message. A cc field 426 may be configured to indicate to courtesy copy recipient(s) of the message. A subject field 428 may be configured to provide the sender's designated subject for the message. Also included is an attachment field 430, which may be configured to indicate a file that has been attached to the received message. In the nonlimiting example of FIG. 4, the attachment is bobkelso.jpg. As also illustrated, the message interface 420 includes a message portion 432. An attachment icon 434 is also included. By selecting the attachment icon 434, the user can view the attachment.

FIG. 5 illustrates an exemplary embodiment of an attachment window 520 for determining attachment options for an outgoing reply message, similar to the interface 420 from FIG. 4. As illustrated, by selecting an options option 522, a reply option 524, a replay all option 526, a forward option 528, and/or an attachment option 530, the attachment window 520 may be presented. The attachment window 520 may be configured to determine whether to include the attachment and/or other options when replying to the received message displayed in interface 420.

More specifically, the user can select attachment options for one or more of the users designated in the message. As a nonlimiting example, the attachment window 520 may be configured to provide options of including the attachment (option 532), including a hyperlink to the attachment (option 534), not including the attachment (option 536), and/or including a summary of the attachment (option 538).

By selecting the attachment option 532, the user can attach the received attachment to the new message, as usual. Similarly, by selecting the include no attachment option 536, the attachment will not be sent in the new message, but an indication of the attachment will be included (similar to the indication 430 from FIG. 4).

By selecting the hyperlink option 534, the attachment (and/or authentication information for accessing the attachment) can be sent to a server that provides messaging services to the user (e.g., server 106a). The server 106 can store the attachment for access by the designated recipient(s) and/or the user who sent the message. Additionally, the new message can include a hyperlink to the stored attachment for the recipient(s) and/or user to easily access the stored attachment. Depending on the particular configuration, the message may also include authentication information to provide security in granting access to the attachment. Upon receiving the new message, the recipient (in this nonlimiting example Perry, Bob, Elliot, and/or Jordan) can access the attachment via the hyperlink. Upon viewing the attachment, the recipient can be provided with an option (not explicitly shown) to reattach the attachment to the message. If this option is selected, the attachment can be reattached to the received email.

Similarly, by selecting the summary option 538, the messaging logic 299 (and/or the user) may be configured to determine a summary of the attachment. Depending on the type of file being attached, the summary may vary. As a nonlimiting example, if the attached file is a textual document, the summary may be one or more excerpts from the document. If the attached file is a video, one or more screenshots may be used as the summary. Similarly, in some embodiments, a lower quality video may be used as the summary. Other types of summaries may be utilized, as well.

Also included are “always use this” options 540. The “always use this” options 540 can allow the user to create a rule for always taking the selected action when that particular recipient is designated as that type of recipient (e.g., Perry Cox in the to field of the new message, Bob Kelso in the cc field of the new message, etc.). Other options are also provided.

One should also know that the user can select one or more of the options 532-538. As a nonlimiting example, the user can select the summary option 538 and the hyperlink option 534. In such a configuration, the recipient can be provided with a summary of the attachments, as well as access to the full version of the file via the hyperlink.

FIG. 6 illustrates an exemplary embodiment of an attachment window 640 for providing attachment options for an initiated outgoing message, similar to the attachment window from FIG. 5. As illustrated, a user can create a new message, such as from the interface 320. The user can then be provided with a new message interface 620. The user can select one or more recipients for the message and may determine whether to attach a file to the message. By selecting the attach option 622, the user may be provided with the attachment window 640. Similar to the attachment window 520, the user can select one or more option for attaching a file to a message. However, the nonlimiting example of FIG. 6 illustrates that these options may be provided to newly created messages and/or previously created messages, as in FIG. 5.

One should also note that, referring back to FIG. 3, a recipient of a message with an attachment variation discussed above may also be provided with an indicator to indicate the type of attachment included. As a nonlimiting example, the attachment field 332 from FIG. 3 indicates that an attachment is either present or not present. However, some embodiments may be configured to indicate that a hyperlink attachment is included, that a summary is included and/or other indications.

FIG. 7 illustrates an exemplary embodiment of an attachment rules window 720 for attaching files to outgoing messages, similar to the attachment window from FIG. 6. As illustrated, from the message interface 320, the user can select an options option 328 for providing the attachment rules window 720. The attachment rules option 720 may be configured to allow the user to designate attachment rules for outgoing messages based on whether the recipient is designated in the to field, the cc field, and/or the bcc field. Also included in the nonlimiting example of FIG. 7 is an option 722 for viewing, creating, and/or amending recipient based rules, as discussed in more detail below.

FIG. 8 illustrates an attachment rules window 820 for determining rules based on a desired recipient, similar to the attachment rules window from FIG. 7. As illustrated, the attachment rules window 820 may be configured to view, create, and/or amend rules based on a designated recipient. More specifically, the user can enter a recipient's address and designate the attachment type for that recipient. Additionally, the user can input other criteria, for performing the designation action.

FIG. 9 illustrates an exemplary embodiment of an attachment rules window 920 for determining attachment rules for received messages, similar to the attachment rules window 820 from FIG. 8. As illustrated, the attachment rules window 920 may be configured to view, create, and/or alter attachment rules for received messages. Similar to the options discussed above, the user may designate whether to receive the attachment, a hyperlink to the attachment, no attachment, and/or a summary of the attachment. More specifically, the rules may be configured to determine how to deliver a message and attachment based on whether the user (who receives the message) is designated in the to field, the cc field, and/or the bcc field. Other criteria may also be used in conjunction with these options and/or as a substitute for these options. As a nonlimiting example, the user can designate that whenever a message is received from a predetermined sender, the attachment is replaced with a hyperlink. Other criteria may also be utilized.

However, with regard to the exemplary embodiment of FIG. 9, since the rules relate to the recipient, the attachment may (depending on the particular nonlimiting example) be received with the message by the messaging logic 299. The messaging logic 299 can then determine the attachment rule that applies to the received message. If the message is to include a hyperlink, the messaging logic 299 can remove the attachment. The messaging logic 299 can send the removed attachment to the server 106 for storage. The messaging logic 299 can then include a hyperlink (or other link) in the message in place of the attachment.

Similarly, if the rules indicate that a received message should instead include a summary, rather than the received attachment, the messaging logic 299 may remove the attachment, determine a summary file, and replace the attachment with the summary file. If the rules indicate that no attachment should be included, but an indicator should be included, the messaging logic 299 can remove the attachment and replace the removed attachment with an indicator of the attachment.

FIG. 10 illustrates an exemplary embodiment of a storage rules window 1020, similar to the attachment rules window from FIG. 9. As illustrated in the nonlimiting example of FIG. 10, the user may designate one or more storage rules for storing attachments locally and/or at the server 106. More specifically, storage rules may be designated to store attachments locally for a predetermined amount of time. As a nonlimiting example, if the user designates 5 days as the amount of time for storing attachments locally, upon expiration of the 5 day time limit, the messaging logic can (depending on the particular configuration) remove the attachment from the message, store the attachment at the server 106, insert a hyperlink in place of the attachment, and/or insert a summary in place of the attachment.

Similarly, some storage options may include storing attachments at the server 106 for a predetermined amount of time and, after expiration of that time frame, reinserting the attachment into the message (and/or otherwise storing the attachment locally). Other options may also be included.

FIG. 11 illustrates an exemplary embodiment of a sent folder rules window 1120, similar to the attachment rules window from FIG. 10. As illustrated, the sent folder options may include various options for storing attachments for sent messages. As a nonlimiting example, the user can determining that for outgoing messages, only hyperlinks to attachments are included in the sent folder. Other options include including a summary of attachments in the sent folder. Still other options include substituting a summary and/or hyperlink for the attachment after a predetermined time limit.

More specifically, as illustrated in Table 1, below, a one or more different profiles may be utilized to implement attachment options.

TABLE 1
Attachment Options

| | | | | Network | |
|---|---|---|---|---|---|
| | | Number | Kind | (internal/external | |
| Criteria | Size | of items | of file | or wireless) | Default |
| TO: | >10 meg then 3 | No limit | All | External then 4 | 1 |
| CC: | >1 meg | >5 items | Image | External then 4 | 3 |
| | | | then 5 | | |
| BCC: | — | — | — | | — |
| Domain: | — | — | — | — | 4 |
| Outside_law_firm.com | | | | | |
| Address: | — | — | — | — | 5 |
| CEO@company.com | | | | | |

TABLE 2
Action Type Descriptions

| Type | Description |
|---|---|
| 1 | Complete file |
| 2 | Summary |
| 3 | Compress |
| 4 | Encrypt |
| 5 | Hyperlink |
| 6 | File description |

As illustrated in Tables 1 and 2, the user (sender and/or recipient, depending on the particular configuration) may be provided with various options for designating the sending and/or receipt of attachments. More specifically, the user can designate one or more options based on the address field (the to field, the cc field, the bcc field, etc.), based on address domain (e.g., for anyone outside a certain address extension such as an address outside of “law_firm.com”), based on whether the message is from and/or to a certain address (e.g., CEO@company.com), based on the kind of file, based on the number of attachments, and/or other criteria. Other options, such as those based on addresses with certain extensions, (e.g., those extensions that may be designated as Spam), addresses from certain geographic regions, etc. may also be utilized.

As also illustrated in Table 1, the user can designate a file size of one or more of the attachment(s) for determining the desired action. More specifically, in the nonlimiting example of Table 1, the user can designate that any attachment of a message sent to in the to field that is larger than 10 megabytes be compressed (see also Table 2). As also illustrated in Table 1, the user can set a default option for handling attachments.

As illustrated in Table 2, the actions that may be performed, among others, include attaching the unaltered file, creating and attaching a summary of the file, compressing the file, encrypting the file, including a link to the file, and including a file description. While the nonlimiting example of Table 1 suggests that only one of the actions in Table 2 may be performed, this is a nonlimiting example, as some embodiments may be configured to perform a plurality of actions.

Other options may include providing a thumbnail of the attachment, providing only a title of the attachment, providing only file information regarding the attachment, converting the attachment into a higher quality format for viewing, converting the attachment into a more suitable format for transmitting, including only selected sections of the attachment and/or other options.

FIG. 12 is a flowchart illustrating an exemplary process for providing access to an attachment, such as may be provided in the network from FIG. 1. As illustrated, server 106 may be configured to receive a message that includes an attachment (block 1232). The server 106 can determine whether the message includes an indication to store the attachment at the server (block 1234). Similarly, while the message may include an indication to store the attachment at the server, the server 106 may be configured to store one or more rules with regard to the designated sender and/or recipient. Similarly, the server can receive an indication from the messaging client for the sender and/or recipient to store the attachment at the server 106. Regardless, in response to determining an indication to store the attachment at the server 106, the attachment can be stored at the server 106 (block 1236). The server can then receive a request to view the stored attachment. The server 106 can then determine authentication information for granting access to the stored attachment (block 1238). As discussed above, the authentication information may be received at the server 106 with the attachment. When the request to view the attachment is received at the server 106 (block 1240), the server 106 can utilize the received authentication information to determine whether the requesting party is authorized to view the attachment. If the user is authorized, the server 106 can authenticate the user (block 1242). The server 106 can then provide the user with access to the attachment (block 1244).

FIGS. 13A-13C depict a flowchart illustrating an exemplary process for sending a message, similar to the flowchart from FIG. 12. As illustrated, the messaging logic 299 can receive attachment settings related to outgoing messages (block 1332). The messaging logic 299 can then receive an outgoing message from a user (block 1334). The messaging logic 299 can determine whether the recipient is designated to receive the attachment (block 1336). If the recipient is designated to receive the attachment, the messaging logic 299 can send the message with the attachment (block 1338). The process can then proceed to block 1340. Similarly, if the messaging logic 299 determines that the recipient is not designated to receive the attachment, the messaging logic 299 determines whether the recipient is designated to receive a link to the attachment (block 1340). If the recipient is designated to receive the link, the process proceeds to jump block 1342, continued in FIG. 13B. If the recipient is not designated to receive the link, the process proceeds to jump block 1344, continued in FIG. 13B.

From jump block 1342, the messaging logic 299 can send the attachment to a remote server, such as the server 106 (block 1346). The messaging logic 299 can send authentication information regarding users with access to the attachment to the remote server 106 (block 1348). The messaging logic 299 can determine a location where the attachment is stored by the remote server 106 (block 1350). The messaging logic 299 can send the message with a link to the attachment substituted for the attachment (block 1352). The process can then proceed to block 1354. Similarly, from jump block 1344, the process proceeds to block 1354 to determine whether the recipient is designated to receive a summary of the attachment. If the recipient is designated to receive a summary, the process proceeds to jump block 1356, continued in FIG. 13C. If the recipient is not designated to receive a summary, the process proceeds to jump block 1358, continued in FIG. 13C.

From jump block 1356 in FIG. 13C, the messaging logic 299 can determine a summary for the attachment (block 1360). The messaging logic 299 can then send the message with the determined summary as the attachment (block 1362). The process can then proceed to block 1364. Similarly, from jump block 1358, the process can proceed to block 1364 to determine whether the recipient is designated to receive an indication of the attachment. If the recipient is designated to receive an indication of the attachment, the messaging logic 299 can send the message without the attachment, but with an indication of the attachment (block 1366). If the messaging logic 299 determines that the recipient is not designated to receive an indication of the attachment, the messaging logic 299 can send the message without the attachment (block 1368).

FIGS. 14A-14C depict a flowchart illustrating an exemplary process for delivering a message with attachment options, similar to the flowchart from FIGS. 13A-13C. As illustrated, the messaging logic 299 can determine attachment settings for received messages (block 1432). The messaging logic 299 can receive a message from a sender (block 1434). The messaging logic 299 can then determine whether the recipient is designated to receive the attachment (block 1436). If the recipient is designated to receive the attachment, the messaging logic 299 can deliver the message with the attachment (block 1438). The process then proceeds to block 1440. Similarly, if the recipient is not designated to receive the attachment, the messaging logic 299 can determine whether the recipient is designated to receive a link to the attachment (block 1440). If the recipient is designated to receive a link, the messaging logic 299 can remove the attachment from the message (block 1442). The process then proceeds to jump block 1444, continued in FIG. 14B. If the recipient is designated to not receive a link to the attachment, the process proceeds to jump block 1445, continued in FIG. 14B.

From jump block 1444 in FIG. 14B, the messaging logic 299 can send the attachment to a remote server, such as the server 106 (block 1446). The messaging logic 299 can determine a location where the attachment is stored (block 1448). The messaging logic 299 can replace the attachment with a link to the stored attachment in the message (block 1450). The messaging logic 299 can then deliver the message with the included link to the attachment (block 1452). The process can then proceed to block 1454. Similarly, from jump block 1445, the process can proceed to block 1454 to determine whether the recipient is designated to receive a summary of the attachment. If the recipient is designated to receive a summary, the messaging logic 299 determines a summary for the attachment (block 1456). The messaging logic 299 can replace the attachment with the summary (block 1458). The process can then proceed to jump block 1460, continued in FIG. 14C. Similarly, if the recipient is not designated to receive a summary at block 1454, the process proceeds to jump block 1461, continued in FIG. 14C.

From jump block 1460 in FIG. 14C, the messaging logic 299 can deliver the message (block 1462). The process then proceeds to block 1464. Similarly, from jump block 1461, the process proceeds to block 1464 to determine whether the recipient is designated to receive an indication of the attachment. If the recipient is designated to receive an indication of the attachment, the messaging logic 299 can remove the attachment from the message (block 1466). The messaging logic 299 can replace the attachment with an indication of the attachment in the message (block 1468). The messaging logic 299 can then deliver the message (block 1472). Similarly, from block 1464, if the messaging logic 299 determines that the recipient is not designated to receive an indication of the attachment, the messaging logic 299 can remove the attachment from the message (block 1470). The messaging logic 299 can then deliver the message (block 1472).

The embodiments disclosed herein can be implemented in hardware, software, firmware, or a combination thereof. At least one embodiment disclosed herein is implemented in software and/or firmware that is stored in a memory and that is executed by a suitable instruction execution system. If implemented in hardware, as in an alternative embodiment, embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks might occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for providing an attachment for an outgoing message, comprising:
receiving a message from a sender, the message configured to be sent to at least one recipient, the message including an attachment;
determining whether the at least one recipient is designated to receive the attachment;
in response to determining that the at least one recipient is designated to receive the attachment, sending the message and attachment for delivery to the at least one recipient;
determining a desired attachment representation for the attachment; and
in response to determining a desired attachment representation for the attachment, sending the message for delivery to the at least one recipient.

2. The method of claim 1, wherein determining a desired attachment representation is based up on at least one predetermined recipient preference.

3. The method of claim 1, wherein determining a desired attachment representation is based on at least one of the following: size of the attachment, total size of all attachments, type of file of the attachment, number of attachments, sender preferences, address field, network affiliation, and recipient domain.

4. The method of claim 1, further comprising, in response to determining that the desired attachment representation is a link to the attachment, sending the attachment to a remote server for storage; and
sending authentication information for accessing the stored attachment.

5. The method of claim 4, further comprising:
determining a location of the stored attachment; and
including a link to the stored attachment in the message.

6. The method of claim 1, wherein determining a desired attachment representation for the attachment includes selecting at least one of the following: excluding the attachment, providing a title of the attachment, providing descriptive information of the attachment, providing a summary of the attachment, providing a thumbnail of the attachment, providing a link to the attachment, converting the attachment into a higher quality format for viewing, converting the attachment into a format for transmitting, providing selected sections of the attachment, and providing the attachment in its entirety.

7. The method of claim 1, further comprising determining that the desired attachment representation is a summary of the attachment;
in response to determining that the desired attachment representation is a summary of the attachment determining a summary of the attachment; and
including the summary with the message.

8. A system for providing an attachment for an incoming message, comprising:
a receiving component configured to receive a message from a sender, the message designating at least one user, the message including an attachment;
a first determining component configured to determine whether the recipient desires to receive the attachment;
a first sending component configured to, in response to determining that the recipient desires to receive the attachment, send the message and attachment for delivery to the recipient;
a second determining component configured to determine whether the recipient desires to receive a link of the attachment; and
a removing component configured to, in response to determining that the recipient desires to receive a link of the attachment, remove the attachment from the message and provide the received message and link to the recipient.

9. The system of claim 8, further comprising, a second sending component configured to, in response to determining that the recipient desires to receive a link of the attachment, send the attachment to a remote server.

10. The system of claim 9, further comprising a replacing component configured to replace the attachment with a link to the stored attachment.

11. The system of claim 8, further comprising a third determining component configured to determine whether the recipient desires to receive a summary of the attachment.

12. The system of claim 11, further comprising:
a summary component configured to, in response to determining that the recipient desires to receive a summary of the attachment, determine a summary of the attachment; and
an incorporating component configured to incorporate the summary into the message.

13. The system of claim 8, further comprising:
a fourth determining component configured to determine whether the recipient desires to not receive the attachment, but receive an indication of the attachment;
a removing component configured to remove the attachment from the message; and
an indicator component configured to include an indicator of the attachment with the message.

14. The system of claim 8, wherein the second determining component is configured to analyze at least one user setting to determine whether the user desires to receive a link to the attachment.

15. A computer readable storage medium for facilitating communication of a message, comprising:
first receiving logic configured to receive a message that includes an attachment, the messaging sent from a sender, the message configured for delivery to at least one recipient;
first determining logic configured to determine whether the received message includes an indication to store the attachment at a remote location; and
storing logic configured to, in response to determining that the message includes an indication to store the attachment at a remote location, store the attachment at the remote location.

16. The computer readable storage medium of claim 15, further comprising sending the message to the recipient.

17. The computer readable storage medium of claim 15, wherein the storing logic is further configured to:
remove the attachment from the message;
store the removed attachment at a remote location;
determine a location of the of the stored attachment; and
replace the removed attachment with a link to the stored attachment.

18. The computer readable storage medium of claim 17, further comprising second determining logic configured to determine authentication information for access to the stored attachment.

19. The computer readable storage medium of claim 17, further comprising:
second receiving logic configured to receive, from a requester, a request to access the stored attachment;
authenticating logic configured to authenticate the requester; and
access logic configured to, in response to authenticating the requester, provide the requester with access to the attachment.

20. The computer readable storage medium of claim 19, wherein the requester is at least one of the following: the sender and the at least one recipient.
